(19) United States
(12) Patent Application Publication
(10) Pub. No.: US 2012/0208052 A1
(43) Pub. Date: Aug. 16, 2012

(54) Battery pack

(76) Inventor: Youn-Gu Kim, Yongin-si (KR)

(21) Appl. No.: 13/317,644

(22) Filed: Oct. 25, 2011

(30) Foreign Application Priority Data
Feb. 11, 2011 (KR) 10-2011-0012379

(51) Int. Cl. H01M 2/12; H01M 2/02

(52) U.S. Cl. 429/82

(57) ABSTRACT

A battery pack includes at least one secondary battery and a case that accommodates the at least one secondary battery. In the battery pack, at least one gas exhausting portion is provided at one side of the case.

### BACKGROUND

1. Field

Embodiments described herein relate to a battery pack, and more particularly, to a battery pack including one or more secondary batteries.

2. Description of the Related Art

The shapes of secondary batteries can be freely changed depending on external electronic devices in which the secondary batteries are employed. Since the secondary batteries can effectively accumulate energy as compared with their volume and mass, they are frequently used as power sources of portable electronic devices.

For example, in a case where an external electronic device requires a high-power source, a plurality of secondary batteries can be configured as one battery pack to be commercialized.

The battery pack configured above may include one or more cases that can accommodate the secondary batteries in the interior thereof. In this instance, the shape of the case may be variously implemented by an external electronic device in which the battery pack is employed.

### SUMMARY

According to an embodiment, there is provided a battery pack including at least one secondary battery, and a case that accommodates the at least one secondary battery, wherein at least one gas exhausting portion is provided at one side of the case.

The gas exhausting portion may include a first gas exhausting portion and a second gas exhausting portion. The first and second gas exhausting portions may be located diagonally on the case with respect to each other.

The gas exhausting portion may include a groove at an inside of the case.

The gas exhausting portion may be adjacent to a corner side of the case.

The gas exhausting portion may have an L-shape.

An edge portion of the gas exhausting portion may be chamfered.

The at least one secondary battery may include a vent. The gas exhausting portion may be adjacent to the vent of the secondary battery.

The at least one secondary battery may be a pouch-type secondary battery. The gas exhausting portion may be adjacent to an electrode tab of the pouch-type secondary battery.

The case may include a first case portion and a second case portion. The first and second case portions may be firmly attached to each other.

The gas exhausting portion may be on at least one of the first and second case portions.

The gas exhausting portion may be on each of the first and second case portions. The gas exhausting portion on the first case portion and the gas exhausting portion on the second case portion may be at positions corresponding to each other.

The gas exhausting portions of the first case portion and the gas exhausting portion of the second case portion may be formed in a same shape.

The case may be made of steel or a molded material.

### BRIEF DESCRIPTION OF THE DRAWINGS

The above and other features will become more apparent to those of ordinary skill in the art by describing in detail exemplary embodiments with reference to the attached drawings, in which:

FIG. 1A illustrates a perspective view of a battery pack according to an embodiment.

FIG. 1B illustrates an exploded perspective view shown in FIG. 1A.

FIG. 2A illustrates an enlarged view of portion A of FIG. 1B.

FIG. 2B illustrates a sectional view taken along line X-X of FIG. 2A.

FIG. 3 illustrates a perspective view of a second case according to another embodiment.

FIG. 4 illustrates an exploded perspective view of a battery pack according to still another embodiment.

FIG. 5A illustrates a perspective view of a battery pack according to still another embodiment.

FIG. 5B illustrates an exploded perspective view of the battery pack shown in FIG. 5A.

### DETAILED DESCRIPTION

Korean Patent Application No. 10-2011-0012379, filed on Feb. 11, 2011, in the Korean Intellectual Property Office, and entitled: “Battery Pack” is incorporated by reference herein in its entirety.

Example embodiments will now be described more fully hereinafter with reference to the accompanying drawings; however, the embodiments may be embodied in different forms and should not be construed as limited to the embodiments set forth herein. Rather, these embodiments are provided so that this disclosure will be thorough and complete, and will fully convey the scope thereof to those skilled in the art. Like reference numerals refer to like elements throughout.

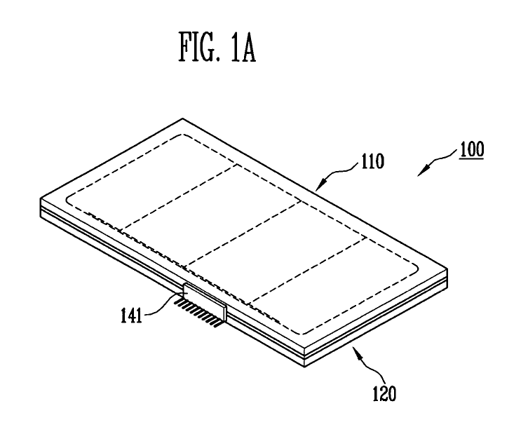

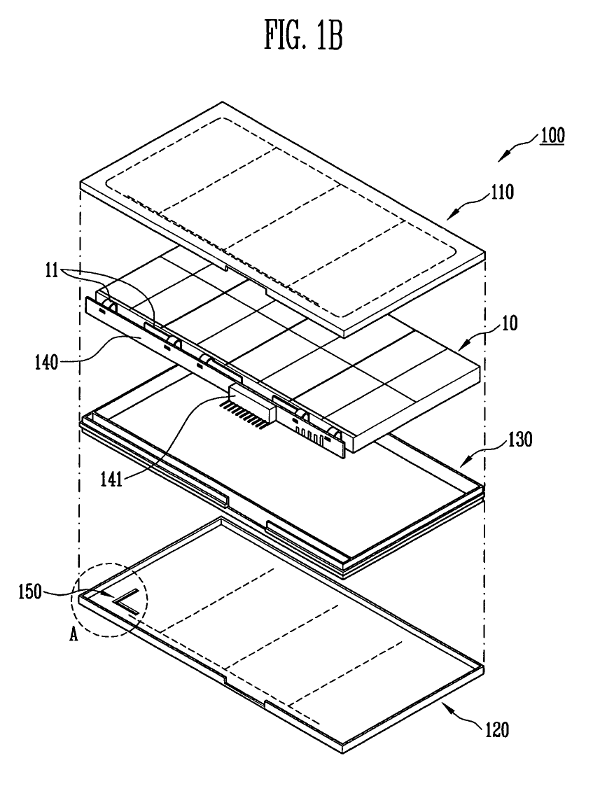

FIG. 1A is a perspective view of a battery pack according to an embodiment. FIG. 1B is an exploded perspective view shown in FIG. 1A.

The battery pack 100 according to this embodiment includes at least one secondary battery 10 and a case made up of case portions 110 and 120 that accommodates the secondary batteries 10. One or more gas exhausting portions 150 are provided at one side of at least one of the case portions 110 and 120.

Referring to FIGS. 1A and 1B, the battery pack 100 according to this embodiment may be formed by accommodating the plurality of secondary batteries 10 and a protection circuit module 140 electrically connected to the secondary batteries 10 in the case portions 110 and 120 having an approximately rectangular shape.

The secondary battery 10 may be a rechargeable lithium secondary battery. The secondary battery 10 may be manufactured by accommodating an electrode assembly and an electrolyte in the interior thereof. The electrode assembly may include of a positive electrode plate, a negative electrode plate and a separator interposed between these electrode plates. Electrochemical energy generated by the electrode assembly and the electrolyte may be transferred to the exterior of the secondary battery by electrode tabs 11. In the secondary battery 10, the case that accommodates the electrode assembly may be a can-type case (cylindrical or prismatic case) formed into a metal can or a pouch-type case formed into a pouch in which the form of a thin film can be freely changed.

The secondary battery 10 according to this embodiment includes a pouch-type secondary battery. The electrode tabs 11 respectively connected to the positive and negative electrode plates are extracted to the exterior of the secondary battery 10. The electrode tabs 11 are electrically connected to the protection circuit module 140. The plurality of secondary batteries 10 may be connected in parallel or series, which may be variously modified according to the battery pack 100.

The protection circuit module 140 may include a protection circuit board having a conductive metal pattern formed therein, protection circuit elements and a connector 141. The protection circuit module 140 functions to control the charge/discharge state, current, voltage or temperature of the secondary battery 10. The connector 141 may be attached to the protection circuit module 140 so as to protrude outward. The connector 141 may be exposed to the exterior through the case portions 110 and 120 and connected to an external electronic device so as to serve as a path through which power is supplied to the external electronic device.

The protection circuit module 140 may be electrically connected to the plurality of secondary batteries 10. The battery pack 100 may further include a side frame 130. The side frame 130 facilitates the accommodation of the secondary batteries 10 and the protection circuit module 140 in the case portions 110 and 120 by fixing the secondary batteries 10 and the protection circuit module 140. A groove with a shape corresponding to the connector 141 may be provided to the side frame 130 so as to fix the connector 141 and facilitate the connector 141 to protrude outward.

The case portions 110 and 120 may have an approximately rectangular shape, which may be variously modified according to the usage of the battery pack 100 and the arrangement of the secondary batteries 10 accommodated in the case. The case 110 and 120 according to this embodiment include a first case portion 110 and a second case portion 120. The first and second case portions 110 and 120 may be formed to be firmly attached to each other. For example, the case portions 110 and 120 may be made of a steel or molded material.

The first and second case portions 110 and 120 may include a gas exhausting portion 150 provided to at least one thereof. The gas exhausting portion 150 may include a groove provided to an inside of the first or second case portion 110 or 120.

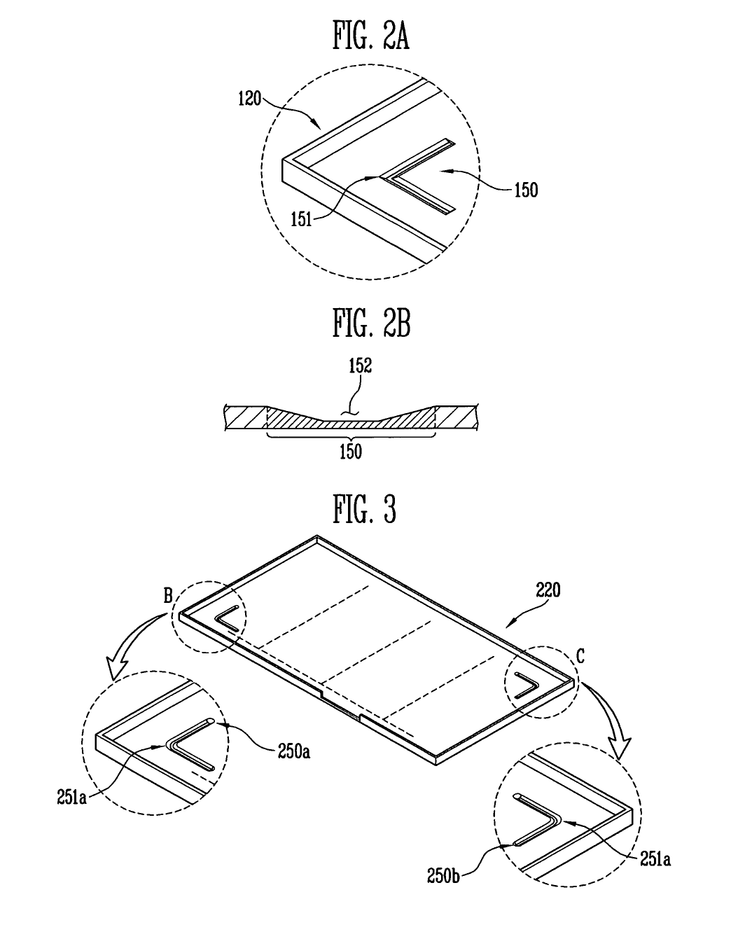

FIG. 2A is an enlarged view of portion A of FIG. 1B. FIG. 2B is a sectional view taken along line X-X of FIG. 2A.

Referring to FIGS. 2A and 2B, the gas exhausting portion 150 may be provided adjacent to a corner of the second case portion 120 in the inside of the second case portion 120. The gas exhausting portion 150 may be formed in an L-shape 151 (for example, a shape having two portions that form a right angle with each other) along the shape of the corner of the second case portion 120.

The battery pack 100 according to this embodiment has the plurality of battery batteries 10 provided in the interior thereof. The secondary battery 10 may have a high charge/discharge operation voltage, and a side reaction between the electrolyte and the electrode assembly may occur in the state that a high voltage is applied to the secondary battery 10. Alternatively, a side reaction in which the electrolyte is decomposed at a high temperature may occur due to heat generated during the operation of the secondary battery 10. Therefore, gas may be generated by the side reaction in the interior of the secondary battery 10. The gas may cause the secondary battery 10 to be expanded by increasing the internal pressure of the secondary battery 10. In a case where the side reaction is maintained or occurs at a certain level or higher, a problem may be caused in the stability of the secondary battery 10. In order to prevent such a problem, a vent for exhausting gas may be provided to the secondary battery 10, and the gas is exhausted to the exterior of the secondary battery 10 through the vent.

In the battery pack 100 having the plurality of secondary batteries 10, the internal pressure of the battery pack 100 may be increased by gas exhausted from the secondary batteries 10. Therefore, the battery pack 100 may be expand by the exhausted gas. Further, there is a risk that the battery pack 100 may become overheated or may explode.

In the battery pack 100 according to this embodiment, the gas exhausting portion 150 may be provided to at least one side of the first or second case portion 110 or 120. In a situation where the internal pressure of the battery pack 100 is increased, the gas exhausting portion 150 may be opened first before the battery pack 100 is broken.

Generally, an electronic device may be designed so that the volume of the electronic device is decreased for the purpose of portability, and a battery pack used as a power source of the electronic device may be adhered closely to the electronic device. Therefore, in a situation where the battery pack is broken, the electronic device having the battery pack adhered thereto may also be damaged. On the other hand, with the battery pack 100 according to the present embodiment, including the gas exhausting portion 150, in a situation where the internal pressure of the battery pack 100 is at a predetermined pressure or higher, gas is exhausted to the exterior of the battery pack 100 through the gas exhausting portion 150. Accordingly, the battery pack 100 is not broken, and the electronic device having the battery pack 100 adhered thereto may receive no damage. Accordingly, the battery pack 100 can be stably used.

Where the secondary battery 10 is a pouch-type secondary battery, the gas exhausting portion 150 may be provided adjacent to the electrode tab 11 of the pouch-type secondary battery 10. The portion at which the electrode tab 11 is provided in the pouch-type secondary battery 10 is a portion at which the largest amount of heat is generated and through which the gas is easily exhausted. Thus, when the gas exhausting portion 150 is provided adjacent to the electrode tab 11 of the pouch-type secondary battery 10, the gas exhausted at the side of the electrode tab 11 can be easily exhausted to the exterior of the battery pack 100 through the gas exhausting portion 150.

Referring to FIG. 2B, the gas exhausting portion 150 may include a groove 152 formed in the inside of the second case portion 120. The gas exhausting portion 150 may be formed in the shape of the groove 152 so as to have a thickness thinner than other neighboring portions.

If the gas exhausting portion 150 were to be provided at the exterior of the battery pack 100, a problem may occur in terms of the external appearance of the battery pack 100. Moreover, the adherence of the battery pack 100 to the electronic device may be interrupted if the battery pack 100 is adhered closely to the electronic device. Thus, according to the present embodiment, the gas exhausting portion 150 is preferably provided to the interior of the second case portion 120.

The gas exhausting portion 150 may be formed in the shape of the groove 152, so that the physical strength of the gas exhausting portion 150 can be decreased as compared with other neighboring portions. Thus, in a case where the internal pressure of the battery pack 100 is increased, the gas exhausting portion 150 is first opened, so that it is possible to prevent the battery pack 100 from being broken.

Hereinafter, another embodiment will be described. In the following embodiment, descriptions of components and operations similar to those described with reference to FIGS. 1A to 2B will not be repeated to avoid redundancy.

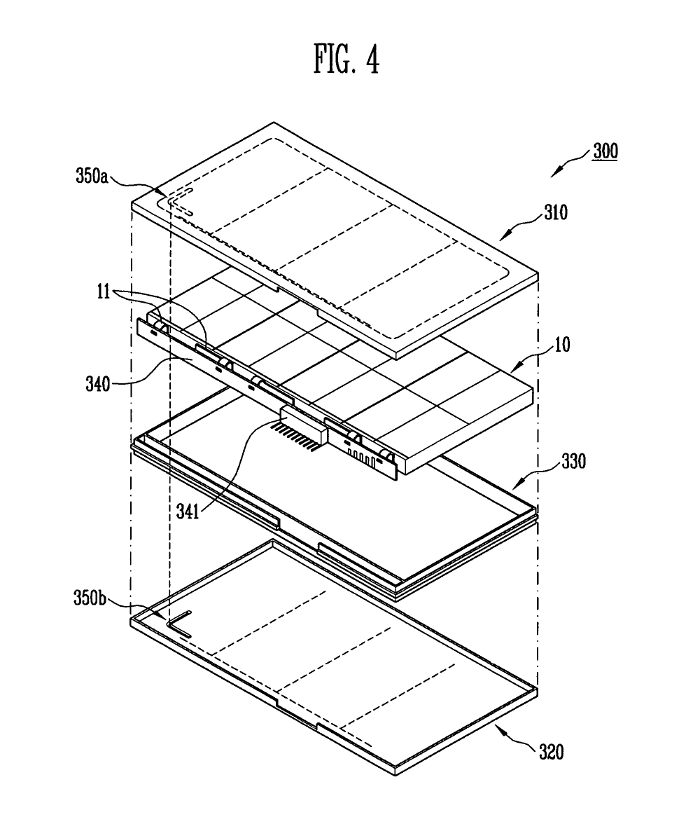

FIG. 3 is a perspective view of a second case according to another embodiment.

Referring to FIG. 3, the battery pack according to this embodiment includes at least one secondary battery, and a first case portion and a second case portion 220, which accommodate the secondary batteries. Gas exhausting portions 250a and 250b may be provided to the second case portion 220.

In the battery pack according to this embodiment, the gas exhausting portions 250a and 250b include a first gas exhausting portion 250a and a second gas exhausting portion 250b. The first and second gas exhausting portions 250a and 250b may be arranged in a diagonal direction to each other. The first or second gas exhausting portion 250a or 250b may be located at opposite corners of the second case portion 220. The first or second gas exhausting portion 250a or 250b may be provided so that the edge portion 251a or 251b of the gas exhausting portion 250a or 250b is chamfered. The first and second gas exhausting portions 250a and 250b may be provided to the same case portion. As electronic devices are generally manufactured to be light in weight and small in size, the battery pack may be provided so that secondary batteries, a protection circuit module and the like are closely aggregated in the interior a case. Because of such a structural configuration, the opening of one of the gas exhausting portions 250a and 250b may be interfered with. In this instance, the other of the gas exhausting portions 250a and 250b may be opened so that gas filled in the interior of the case can be exhausted. The first and second gas exhausting portions 250a and 250b arranged in the diagonal direction to each other are mutually complementarily operated, so that the stability of the battery pack can be more improved.

Referring to portions B and C of FIG. 3, the first or second gas exhausting portion 250a or 250b may be provided so that its edge portion 251a or 251b is chamfered. If the first or second gas exhausting portion 250a or 250b is opened, the gas exhausted from the interior of the case may cause the first or second gas exhausting portion 250a or 250b to protrude toward the exterior of the case. If the first or second gas exhausting portion 250a or 250b were to have a sharp edge portion, the first or second gas exhausting portion 250a or 250b protruding to the exterior of the case may have secondary influence on the exterior of the battery pack, and therefore, a problem may be caused in the stability of the battery pack. Thus, according to the present embodiment, the sharp edge portion 251a or 251b of the first or second gas exhausting portion 250a or 250b is preferably chamfered.

FIG. 4 is an exploded perspective view of a battery pack according to still another embodiment.

Referring to FIG. 4, the battery pack 300 according to this embodiment includes at least one secondary battery 10, and first and second case portions 310 and 320 that accommodate the secondary batteries 10. Gas exhausting portions 350a and 350b may be provided to the first and second case portions 310 and 320, respectively.

Side portions of the plurality of secondary batteries 10 connected in series or parallel and a protection circuit module 140 electrically connected to the secondary batteries 10 may be fixed by a side frame 340, so that the plurality of secondary batteries 10 and the protection circuit module 140 can be easily mounted in the interior of the first and second case portions 310 and 320. The protection circuit module 140 may be provided with a connector 141 that connects the protection circuit module 140 to an external electronic device.

In the battery pack 300 according to this embodiment, the gas exhausting portions 350a and 350b are provided to both the first and second case portions 310 and 320. The gas exhausting portions 350a and 350b respectively provided to the case portions 310 and 320 may be at positions corresponding to each other. The gas exhausting portions 350a and 350b of the first and second case portions 310 and 320 may be formed in the same shape.

The first and second case portions 310 and 320 may be formed approximately in the shape of a tetrahedron having an opened side. The first and second case portions 310 and 320 may come in contact with each other so that the opened sides of the first and second case portions 310 and 320 correspond to each other. Therefore, although the shapes of the first and second case portions 310 and 320 may be different at the portion at which the first and second case portions 310 and 320 come in contact with each other, wide surfaces of the first and second case portions 310 and 320, which accommodate the secondary batteries 10, are approximately formed in the same shape. Thus, if the gas exhausting portions 350a and 350b of the first and second case portions 310 and 320 are formed in the same shape at the positions corresponding to each other, molds for manufacturing the first and second case portions 310 and 320 can be integrally formed, thereby reducing production cost. Further, the gas exhausting portions 350a and 350b may be provided to the respective first and second case portions 310 and 320, corresponding to the electrode tab 11 of the secondary battery 10, at which the largest amount of gas is exhausted, so that the gas generated in the interior of the battery pack 300 can be effectively exhausted.

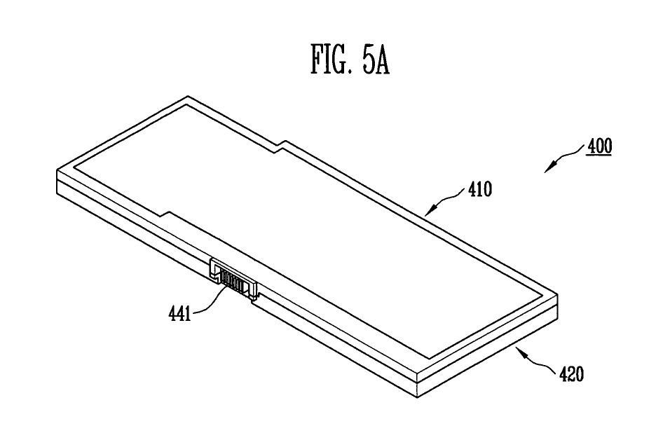

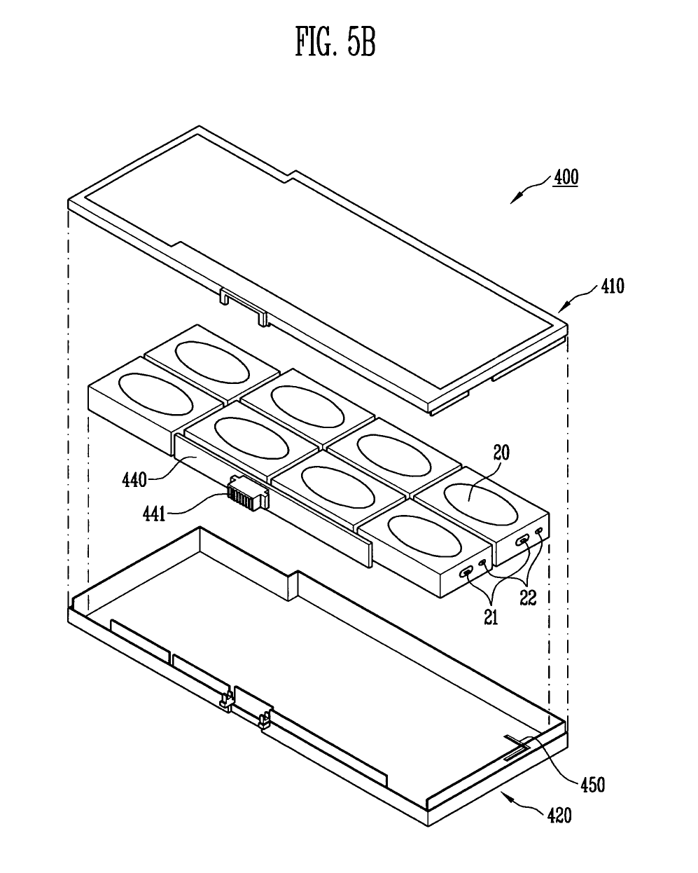

FIG. 5A is a perspective view of a battery pack according to still another embodiment. FIG. 5B is an exploded perspective view of the battery pack shown in FIG. 5A.

Referring to FIGS. 5A and 5B, the battery pack 400 according to this embodiment includes at least one secondary battery 20, and first and second case portions 410 and 420 that accommodate the secondary batteries 20. A gas exhausting portion 450 may be provided to the second case portion 420.

The battery pack 400 according to this embodiment may include a plurality of prismatic secondary batteries 20 accommodated in the interior thereof.

The prismatic secondary battery 20 may be manufactured by accommodating an electrode assembly and an electrolyte in a can having an opened side and then sealing the can with a cap assembly having a negative electrode pin 21 and a vent 22. In a case where the amount of gas generated in the interior of the secondary battery 20 sealed by the cap assembly is a predetermined amount or more, the gas is exhausted to the exterior of the secondary battery 20 through the vent 22.

In the battery pack 400 including the secondary batteries 20 each having the vent 22, the gas exhausting portion 450 may be provided adjacent to the vent 22 of the secondary battery 20. The gas generated in the interior of the secondary battery 20 is a gas generated by a side reaction of the electrode assembly and the electrolyte. The gas may have bad influence on a protection circuit module 440 or connector 441 provided to the interior of the battery pack 400, or on neighboring secondary batteries 20. Thus, the gas exhausting portion 450 is preferably provided adjacent to the vent 22 so that the gas exhausted from the secondary battery 20 does not remain in the interior of the battery pack 400 but is immediately exhausted to the exterior of the battery pack 400.

Although it has been described in this embodiment that the vent 22 is provided to the cap assembly of the secondary battery 20, the shape and position of the vent 22 may be variously modified. In this instance, the gas exhausting portion 450 may be properly changed depending on the position of the vent 22.

By way of summation and review, according to embodiments, it is possible to provide a battery pack in which heat generated in the interior of secondary batteries may be controlled and dissipated to the exterior of the battery pack.

Also, it is possible to provide a battery pack in which gas generated in the interior of secondary batteries may be stably exhausted. Thus, it is possible to improve the stability of an electronic device having the battery pack mounted thereto.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope thereof as set forth in the following claims.

What is claimed is:

1. A battery pack comprising:
at least one secondary battery; and
a case that accommodates the at least one secondary battery,
wherein at least one gas exhausting portion is provided at one side of the case.

2. The battery pack as claimed in claim 1, wherein:
the gas exhausting portion includes a first gas exhausting portion and a second gas exhausting portion, and
the first and second gas exhausting portions are located diagonally on the case with respect to each other.

3. The battery pack as claimed in claim 1, wherein the gas exhausting portion includes a groove at an inside of the case.

4. The battery pack as claimed in claim 1, wherein the gas exhausting portion is adjacent to a corner side of the case.

5. The battery pack as claimed in claim 1, wherein the gas exhausting portion has an L-shape.

6. The battery pack as claimed in claim 1, wherein an edge portion of the gas exhausting portion is chamfered.

7. The battery pack as claimed in claim 1, wherein:
the at least one secondary battery includes a vent, and
the gas exhausting portion is adjacent to the vent of the secondary battery.

8. The battery pack as claimed in claim 1, wherein:
the at least one secondary battery is a pouch-type secondary battery, and
the gas exhausting portion is adjacent to an electrode tab of the pouch-type secondary battery.

9. The battery pack as claimed in claim 1, wherein:
the case includes a first case portion and a second case portion, and
the first and second case portions are firmly attached to each other.

10. The battery pack as claimed in claim 9, wherein the gas exhausting portion is on at least one of the first and second case portions.

11. The battery pack as claimed in claim 9, wherein:
the gas exhausting portion is on each of the first and second case portions, and
the gas exhausting portion on the first case portion and the gas exhausting portion on the second case portion are at positions corresponding to each other.

12. The battery pack as claimed in claim 11, wherein the gas exhausting portion on the first case portion and the has exhausting portion on the second case portion are formed in a same shape.

13. The battery pack as claimed in claim 1, wherein the case is made of steel or a molded material.
